(19) United States
(12) Patent Application Publication
(10) Pub. No.: US 2017/0297362 A1
(43) Pub. Date: Oct. 19, 2017

(54) HANGING FILE SYSTEM

(71) Applicant: IRIS USA, Inc., Pleasant Prairie, WI (US)

(72) Inventors: Bethany Bauer, Kenosha, WI (US); Susumu Kobayashi, Watari (JP)

(21) Appl. No.: 15/099,903

(22) Filed: Apr. 15, 2016

(51) Int. Cl. B42F 15/00

(52) U.S. Cl. CPC B42F 15/0094

(57) ABSTRACT

A hanging file system having a container with a wall structure extending around a file storage space and first and second substantially parallel rails. The rails are configured to operatively support a first file folder having spaced hanging components that cooperate with the first and second rails to guide movement of the first file holder in a first predetermined translatory path. Third and fourth rails operatively support a second file folder having spaced hanging components that cooperate with the third and fourth rails to guide movement of the second file folder in a second predetermined translatory path. The first and second translatory paths extend respectively along first and second lines that are angled with respect to each other.

### BACKGROUND OF THE INVENTION

### Field of the Invention

This invention relates to hanging file systems and, more particularly, to a system wherein hanging folders in which files are placed are movable guidingly in predetermined paths.

### Background Art

Hanging file systems are used commonly in drawers and in association with other types of receptacles to store, and facilitate handling of, files. Individual folders are configured to store one or more files. A typical folder consists of a folded sheet that produces an upwardly opening file receptacle. The upper edges of the folded sheet parts each has oppositely projecting hanging components that cooperate with spaced, parallel rails that define a predetermined path for movement of each folder and its contained file(s). Commonly, the hanging components will be defined on a metal strip integrated into each sheet part at its upper edge. The strip has a notch or cutout at each end bounded by an inverted U-shaped edge that loosely straddles a rail and guides movement of its respective sheet part therealong.

With the above arrangement, a number of file folders can be suspended and translated guidingly along a path dictated by the rails. The sheet parts can be separated to access the contained folder(s) while maintaining the folder in its hanging position. Alternatively, each folder can be lifted off of its associated guide rails to facilitate handling of, and access to, a contained file.

It is known to form guide rails using elongate rods or straps. The rods and/or straps may be permanently incorporated into a drawer or other type of receptacle. The rail defining structure may alternatively be separately incorporated to be separable, as desired. An exemplary form is shown in U.S. Pat. No. 4,726,635.

In an alternative known structure as shown, for example, in U.S. Patent Application Publication No. 2015/0375558, a container with a peripheral wall bounding a file storage space has a ledge integrally formed with the peripheral wall. The ledge functions as a guide rail and supports the hanging components which are confined lengthwise by facing surfaces that project upwardly from the ledges.

Normally, a drawer, or particular container in which the files are to be stored, has a width transversely to the travel path for the hanging files that is dimensioned to accommodate one of either legal or letter size files.

Dedicated racks have been devised, as shown in U.S. Pat. No. 4,901,867, that allow suspended files to translate guidingly in different paths. U.S. Pat. No. 4,901,867 uses an integral wire structure to define both the file receptacle and the guide rails for the hanging files.

Heretofore, containers with integrally formed guide rails, such as in U.S. Patent Application Publication No. 2015/0375558, have not been configured to either: a) accommodate files of different size; or b) allow guided movement of different groups of suspended files in different directions.

The industry continues to seek out different file hanging systems which afford a user greater versatility while maximizing use of available file space.

### SUMMARY OF THE INVENTION

In one form, the invention is directed to a hanging file system that includes a container having a wall structure extending around a file storage space and first and second substantially parallel rails. The rails are configured to operatively support a first file folder having spaced hanging components that cooperate with the first and second rails to guide movement of the first file folder in a first predetermined translatory path. The hanging file system further includes third and fourth substantially parallel rails. The third and fourth rails are configured to operatively support a second file folder having spaced hanging components that cooperate with the third and fourth rails to guide movement of the second file folder in a second predetermined translatory path. The first and second translatory paths extend respectively along first and second lines that are angled with respect to each other.

In one form, the hanging file system is provided in combination with the first and second file folders. The operatively supported first and second file folders reside within the file storage space.

In one form, the wall structure defines an upwardly opening cup shape.

In one form, the wall structure and first and second rails are formed as one molded piece.

In one form, the wall structure defines an upwardly opening cup shape. The wall structure and first, second, and third rails are formed as one molded piece.

In one form, the container has a top and bottom. The wall structure has a stepped region adjacent to the top of the container. The stepped region consists of an upwardly facing surface and a peripheral rim extending around the upwardly facing surface. The first and second rails project upwardly from the upwardly facing surface.

In one form, the first, second, and third rails are formed as one molded piece. The third rail projects upwardly from the upwardly facing surface.

In one form, the fourth rail is defined by at least one component that is attached to the container and spans the first and second rails.

In one form, the wall structure has first and second walls with facing surfaces that bound the file storage space. The first rail is formed as one piece with the first wall and the second rail is formed as one piece with the second wall.

In one form, the wall structure has third and fourth walls with facing surfaces that bound the file storage space. The third rail is formed as one piece with the third wall.

In one form, at least a part of each of the first, second, third, and fourth walls is formed as one molded piece.

In one form, the first and second rails define first and second upwardly facing edges on the wall structure to bear against operatively supported file folders. The fourth rail has at least one component that spans the first and second upwardly facing edges.

In one form, the at least one component has an elongate shape with a length between first and second spaced ends. One of the ends extends through one of the first and second rails.

In one form, the wall structure defines an upwardly opening receptacle. The one end of the at least one component extends into the upwardly opening receptacle with the at least one component operatively positioned. The one rail has a receiver bounded by an edge to engage a part of the at least one component adjacent to the one end and is configured so that the receiver edge stabilizes the one end of the at least one component.

In one form, the receiver edge has an upwardly opening “U” shape. The one end of the at least one component is “L”-shaped with a horizontal leg and a vertical leg. The vertical leg extends into the upwardly opening receptacle and the horizontal leg bears against the receiver edge with the at least one component operatively positioned.

In one form, the container and fourth rail are configured so that the at least one component, initially in a starting position separated from the container, can be operatively positioned by a press fitting the at least one component.

In one form, the other end of the at least one component and container are configured to cooperate in the same manner as the one end of the at least first component and container cooperate.

In one form, the at least one component comprises a U-shaped component.

In one form, the third and fourth rails define third and fourth upwardly facing edges to bear against operatively supported file folders. The first, second, third, and fourth edges reside substantially in a single plane.

In one form, the first and second file folders each has spaced hanging components with an inverted U-shaped edge that straddles a respective rail with the first and second file folders operatively supported.

### BRIEF DESCRIPTION OF THE DRAWINGS

FIG. 1 is a schematic representation of a file folder that is usable with the present invention;

FIG. 2 is a front elevation view of one specific form of file folder as shown in FIG. 1;

FIG. 3 is a side elevation view of the file folder in FIG. 3;

FIG. 4 is a schematic representation of a hanging file system, according to the present invention, usable to cooperate with file folders as shown in FIGS. 1-3;

FIG. 5 is a perspective view of one exemplary form of file system, as shown schematically in FIG. 4, and including a container and guide rails for file folders;

FIG. 6 is a plan view of the file system in FIG. 5;

FIG. 7 is a fragmentary, perspective view of the file system in FIGS. 5 and 6;

FIG. 8 is an enlarged, fragmentary, exploded, perspective view showing the connection between one end of a component defining a guide rail and the container in FIGS. 5-7;

FIG. 9 is an enlarged, fragmentary view showing the relationship between a hanging component on a file folder, as in FIGS. 1-3, and the guide rail in FIG. 8;

FIG. 10 is an enlarged, cross-sectional view of the container taken along line 10-10 of FIG. 6 and with a boss broken away to show the connection between the guide rail component in FIG. 8 and the container;

FIG. 11 is an enlarged, cross-sectional view of the container taken along line 11-11 of FIG. 6 and showing the interaction between a guide rail on the container and a hanging component on a file folder as in FIGS. 1-3;

FIG. 12 is an enlarged, front elevation view of the guide rail component as shown in FIGS. 8-10; and

FIG. 13 is an enlarged, fragmentary, perspective view corresponding to that in FIG. 8 and showing the guide rail operatively connected.

### DETAILED DESCRIPTION OF THE PREFERRED EMBODIMENT

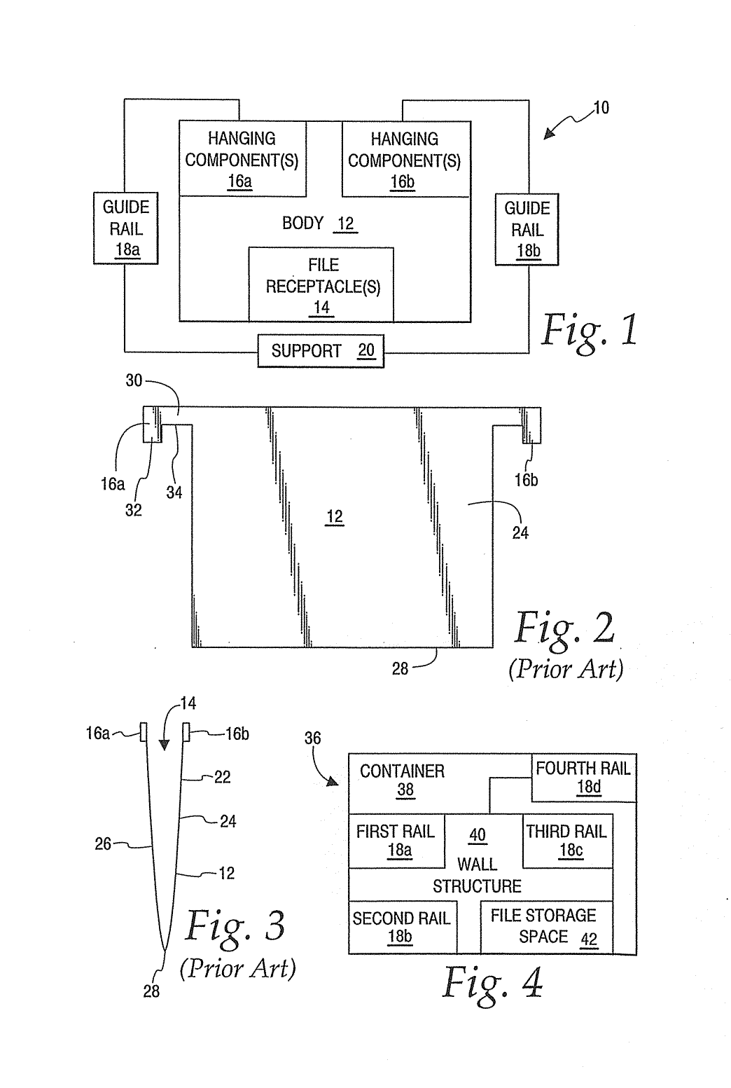

The invention is directed to a hanging system for file folders of the type shown schematically at 10 in FIG. 1. The file folder 10 has a body 12 that defines at least one receptacle 14 for files. Typically, the body 12 will be made from a flexible sheet that is folded in half against itself to define an upwardly opening receptacle configuration. However, this is not a requirement.

The body 12 has at least one hanging component 16a, 16b at the sides thereof. The hanging components 16a, 16b cooperate with first and second guide rails 18a, 18b on an appropriate support 20. The hanging components 16a, 16b are typically provided adjacent the top of the body 12 so that the body 12 is supported in depending fashion. The hanging components 16a, 16b cooperate, one each, with the guide rails 18a, 18b so that the file folder 10 is guided in a predetermined, translatory path dictated by the guide rails 18a, 18b.

The schematic showing of the file folders 10 is intended to encompass one specific form, as described below, and virtually an unlimited number of variations thereof that can be utilized as part of the inventive system. The specific form for the file folder 10 in FIGS. 2 and 3 is exemplary in nature only.

As depicted, the body 12 is made from a sheet 22 with separate parts 24, 26 folded against each other about a fold line 28 to define the upwardly opening receptacle 14 within which individual files can be placed.

The hanging components 16a, 16b are integrated into the body 12 either as one piece or as separate components. The hanging components 16a, 16b have the same configuration. As seen for exemplary hanging component 16a, a body 30 that projects horizontally away from the folder body 12, has a downwardly directed end 32. The bodies 12, 30 cooperatively define an inverted U-shaped edge 34 that will loosely straddle the guide rail 18a to allow sliding movement thereagainst without significant binding.

As noted above, this file folder construction is only exemplary in nature, as the inventive concept can be utilized to accommodate virtually any file folder configuration that is supported upon, and guided along, rails 18a, 18b.

The inventive hanging file system, that cooperates with the file folders 10, is shown in schematic form at 36 in FIG. 4. Again, the schematic showing is intended to encompass the specific form as described herein for the file system 36 and variations of all of the components thereof and their interaction as would be obvious to one skilled in the art with the present teachings in hand.

The file system 36 consists of a container 38 with a wall structure 40 that supports the aforementioned first and second rails 18a, 18b and additionally cooperating third and fourth rails 18c, 18d respectively. The wall structure 40 is not limited in construction and primarily supports the rails 18a-18d and extends around a file storage space 42 within which suspended file folders 10 can reside.

While not a requirement, the first, second, and third rails 18a-18c may be integrated into the wall structure 40, as by being a permanent/integral part thereof. However, one or more of the rails 18a-18c could be separately formed and attached to make up the wall structure 40. As depicted, the fourth rail 18d is a separate component which is ideally separable from the wall structure 40.

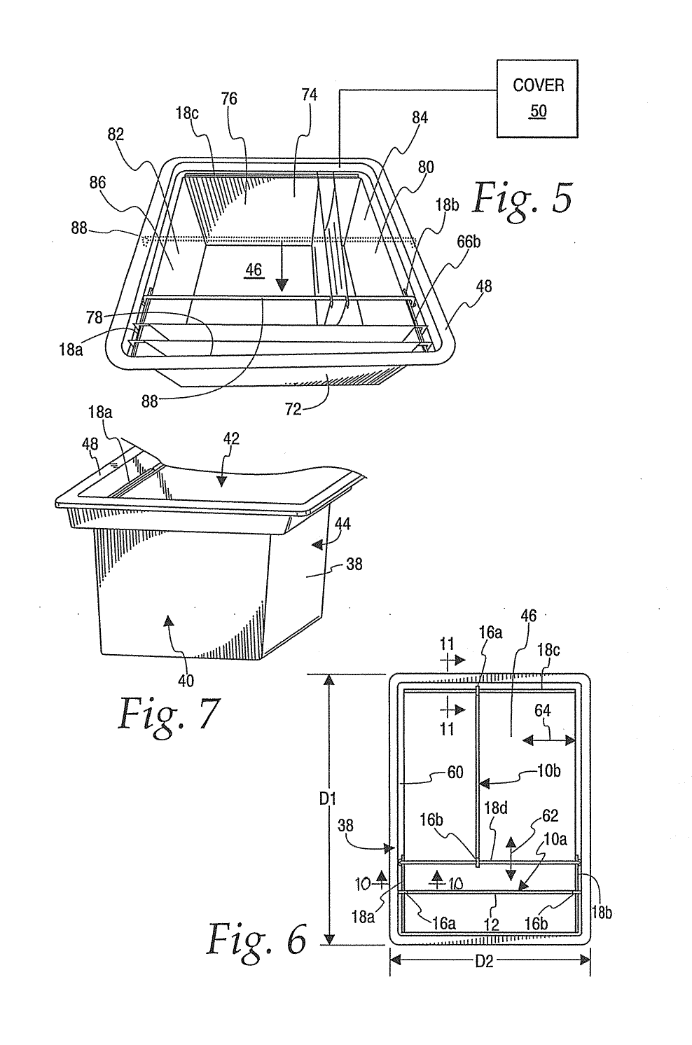

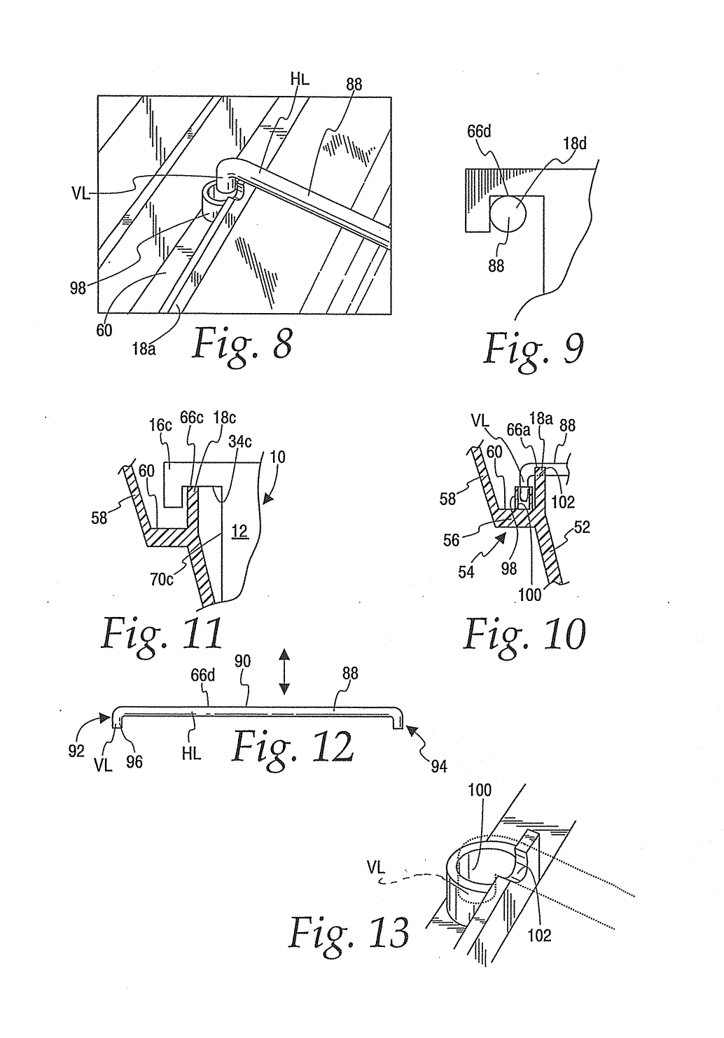

The schematic showing of the file system 36 is intended to encompass a multitude of different constructions using potentially many different materials. One specific preferred form will now be described with respect to FIGS. 5-13.

The container 38 has a wall structure 40 with a peripheral wall portion 44 and a bottom wall 46 bounding a cup-shaped, upwardly opening file storage space 42. The peripheral wall portion 44 terminates at an upper surface 48 which can accept an optional cover 50 to allow selective closing of the file storage space 42. The container 38 thus has the overall form of commonly used plastic storage bins. With the closed construction, the file storage space 42 can be used to contain other objects in addition to files in the folders 10. As noted above, this particular construction is not required.

The wall portion 44 has generally the same overall cross-sectional shape, as seen clearly in FIGS. 10 and 11, around the container periphery. A primary vertical wall portion 52 may be fully vertical or slightly angled, as in the depicted embodiment. The wall structure 40 has a stepped region at 54 adjacent to the top of the container 38. At this region 54, an outwardly projecting ledge 56 is formed which blends into a peripheral rim 58 that terminates at the upper surface 48. The ledge 56 defines an upwardly facing surface 60 continuously around the file storage space 42. The rim 58 extends fully around the surface 60.

The first and second rails 18a, 18b project upwardly from the surface 60 over a part of the dimension D1, as seen in the FIG. 6 plan view. In FIG. 6, one exemplary file folder 10a is shown operatively supported on the rails 18a, 18b whereby the hanging components 16a, 16b cooperate with the rails 18a, 18b, respectively, to guide movement of the file folder 10 in a first predetermined translatory path along the dimension D1, as indicated by the double-headed arrow 62. As noted, the rails 18a, 18b do not extend the full dimension D1. However, the rails 18a, 18b could so extend and be integrated to allow overall system operation as described hereinbelow.

As seen most clearly in FIG. 6, the third and fourth rails 18c, 18d operatively support a file folder 10b and are configured to cooperate with the hanging components 16a, 16b thereon to guide movement of the file folder 10b in a second predetermined translatory path, along the dimension D2, as indicated by the double-headed arrow 64.

The first and second translatory paths, indicated by the arrows 62, 64, respectively, extend along lines that are angled with respect to each other. As depicted, the paths are approximately orthogonal to each other. However, this is not a requirement.

In FIG. 6, the file folder 10a is shown to have a narrower construction than the file folder 10b. The file folder 10a may be a conventional letter size, while the file folder 10b may be a conventional legal size. However, the invention contemplates that the system 36 may be usable with only one file folder size.

Further, the shape of the container 38, as seen in plan, does not have to be as depicted. Virtually any shape, including non-square, non-rectangular, etc. is contemplated, as any such shape could be adapted to incorporate the invention.

Further, there is no required combination of long and short file folders 10, if different sizes are even utilized. For example, in one variation from the FIG. 6 configuration, the shorter file folder size may utilize the third and fourth rails 18c, 18d with the longer file folder size utilizing the first and second rails 18a, 18b.

In the embodiment shown, each of the rails 18a, 18b, 18c projects upwardly from the surface 60 and cooperates with the hanger components 16a, 16b in the same manner. As shown for exemplary rail 18c in FIG. 11, the rail 18c defines an upwardly facing edge 66c that bears against the edge 34c on the hanging component 16c. The edge 34c has an inverted “U” shape that loosely straddles the rail 18c with the respective file folder 10 operatively supported. The edge 34c is actually formed in part by an edge portion 70c on the file folder body 12.

In the form depicted, the wall structure 40 is made up of a first pair of walls 72, 74 defining facing surfaces 76, 78 bounding the file storage space 42. A separate pair of walls 80, 82 define surfaces 84, 86 that face each other and also bound the file storage space 42.

While not required, it is preferred that at least one, and preferably all, of the guide rails 18a, 18b, 18c be formed as one piece with its respective wall 74, 80, 82. One preferred construction has a single molded plastic/resin material piece that forms the wall 72, 74, 80, 82 and rails 18a, 18b, 18c. It is preferred that at least part of each of the walls 72, 74, 80, 82 be formed as one molded piece.

While molding is preferred, such a construction is not required.

The fourth guide rail 18d is formed in a different manner and preferably so that it can be removably operably positioned. The fourth wall 18d, while potentially being constructed from multiple components, is shown as a single piece/component 88.

The component 88 has an inverted “U” shape construction with an elongate main body 90 with spaced lengthwise ends 92, 94. The body 90 cooperates with the container 38 at its opposite ends 92, 94 in the same manner. Thus, the explanation herein will be with respect to the cooperation between the exemplary end 92 and the container 38.

The body 90 fully spans the first and second rails 18a, 18b and the guide edges 66a, 66b thereon.

The body end 92 has an overall “L” shape with the overall length of the body 90 making up one horizontal leg HL of the “L” and a downturned bend 96 making up the other/vertical leg VL of the “L”.

A boss 98 projects upwardly from the surface 60 and defines an upwardly opening receptacle 100 to receive the vertical leg VL with the component 88 operatively positioned as in FIGS. 10 and 13. The guide rail 18a has a receiver formed therein bounded by an upwardly opening U-shaped edge 102 that conforms generally to the cross-sectional shape of the component 88. As the vertical leg VL is pressed into the receptacle 100, a part of the horizontal leg HL nests against the edge 102. The receiver edge 102 stabilizes the connection of the one component end 92 in conjunction with the boss 98. The edge 102 is preferably U-shaped to at least nominally match the cross-sectional configuration of the component 88.

However, while the component 88 is shown to have a round cross-sectional configuration, this is not a requirement and the edge 102 could be correspondingly changed to best stabilize the end 92. The round shape is desirable from the standpoint that it can be made from common round stock and forms a suitable supporting guide edge 66d for the hanging components 16a, 16b.

With the depicted construction, the U-shaped component 88 can be placed in a starting position, fully separated from the container 38, as shown in dotted lines in FIG. 5. By directing the component 88 downwardly, both ends 92, 94 can seat in the same manner to place the component 88 in its operative position. Thus, assembly can be effected through a simple press-fit step. The component 88 and container 38 are configured so that the component 88 can be frictionally maintained in its operative position. Separation can be effected by reversing the assembly step. If desired, supplementary securing structure, such as an adhesive, could be utilized.

With the depicted construction, the upwardly facing edges 66a, 66b, 66c, 66d on the guide rails 18a, 18b, 18c, 18d can all reside in a single plane. This is not a requirement.

The foregoing disclosure of specific embodiments is intended to be illustrative of the broad concepts comprehended by the invention.

1. A hanging file system comprising:
a container having a wall structure extending around a file storage space and first and second substantially parallel rails,
the rails configured to operatively support a first file folder having spaced hanging components that cooperate with the first and second rails to guide movement of the first file folder in a first predetermined translatory path;
the hanging file system further comprising third and fourth substantially parallel rails,
the third and fourth rails configured to operatively support a second file folder having spaced hanging components that cooperate with the third and fourth rails to guide movement of the second file folder in a second predetermined translatory path,
the first and second translatory paths extending respectively along first and second lines that are angled with respect to each other.

2. The hanging file system according to claim 1 in combination with the first and second file folders, the operatively supported first and second file folders residing within the file storage space.

3. The hanging file system according to claim 1 wherein the wall structure defines an upwardly opening cup shape.

4. The hanging file system according to claim 3 wherein the wall structure and first and second rails are formed as one molded piece.

5. The hanging file system according to claim 2 wherein the wall structure defines an upwardly opening cup shape and the wall structure and first, second, and third rails are formed as one molded piece.

6. The hanging file system according to claim 4 wherein the container has a top and bottom, and the wall structure has a stepped region adjacent to the top of the container, the stepped region comprising an upwardly facing surface and a peripheral rim extending around the upwardly facing surface, the first and second rails projecting upwardly from the upwardly facing surface.

7. The hanging file system according to claim 6 wherein the first, second, and third rails are formed as one molded piece and the third rail projects upwardly from the upwardly facing surface.

8. The hanging file system according to claim 5 wherein the fourth rail is defined by at least one component that is attached to the container and spans the first and second rails.

9. The hanging file system according to claim 2 wherein the wall structure comprises first and second walls with facing surfaces that bound the file storage space, the first rail is formed as one piece with the first wall and the second rail is formed as one piece with the second wall.

10. The hanging file system according to claim 9 wherein the wall structure comprises third and fourth walls with facing surfaces that bound the file storage space and the third rail is formed as one piece with the third wall.

11. The hanging file system according to claim 10 wherein at least a part of each of the first, second, third, and fourth walls is formed as one molded piece.

12. The hanging file system according to claim 1 wherein the first and second rails define first and second upwardly facing edges on the wall structure to bear against operatively supported file folders and the fourth rail comprises at least one component that spans the first and second upwardly facing edges.

13. The hanging file system according to claim 12 wherein the at least one component has an elongate shape with a length between first and second spaced ends and one of the ends extends through one of the first and second rails.

14. The hanging file system according to claim 13 wherein the wall structure defines an upwardly opening receptacle and the one end of the at least one component extends into the upwardly opening receptacle with the at least one component operatively positioned, the one rail having a receiver bounded by an edge to engage a part of the at least one component adjacent to the one end and configured so that the receiver edge stabilizes the one end of the at least one component.

15. The hanging file system according to claim 14 wherein the receiver edge has an upwardly opening “U” shape and the one end of the at least one component is “L”-shaped with a horizontal leg and a vertical leg, the vertical leg extending into the upwardly opening receptacle and the horizontal leg bearing against the receiver edge with the at least one component operatively positioned.

16. The hanging file system according to claim 15, wherein the container and fourth rail are configured so that the at least one component initially in a starting position separated from the container can be operatively positioned by a press fitting the at least one component.

17. The hanging file system according to claim 16 wherein the other end of the at least one component and container are configured to cooperate in the same manner as the one end of the at least first component and container cooperate.

18. The hanging file system according to claim 17 wherein the at least one component comprises a U-shaped component.

19. The hanging file system according to claim 12 wherein the third and fourth rails define third and fourth upwardly facing edges to bear against operatively supported file folders and the first, second, third, and fourth edges reside substantially in a single plane.

20. The hanging file system according to claim 2 wherein the first and second file folders each has spaced hanging components with an inverted U-shaped edge that straddles a respective rail with the first and second file folders operatively supported.
